(19) United States
(12) Patent Application Publication
(10) Pub. No.: US 2013/0298408 A2
(43) Pub. Date: Nov. 14, 2013

(54) PILL PEN WITH A PILL CUTTER AND GRINDER

(71) Applicant: Richard Qi Li, Ocala, FL (US)

(72) Inventor: Richard Qi Li, Ocala, FL (US)

(73) Assignee: Richard Qi Li, Ocala, FL (US)

(21) Appl. No.: 13/329,185

(22) Filed: Dec. 16, 2011

Related U.S. Application Data
(60) Provisional application No. 61/457,594, filed on Apr. 27, 2011.

(30) Foreign Application Priority Data
Apr. 27, 2011 (US) 13329185

(51) Int. Cl. A61J 7/00; B25F 1/00

(52) U.S. Cl. 30/124

(57) ABSTRACT

The pill container is shaped like a conventional pen and is composed of multiple cylindrical compartments and a cap. Each compartment is labeled for the medication it contains. The label is attached from inside with a clip. Such labeling method with a clip can be applied to the regular medication organizers to add extra function as a labeled pill container. The last compartment of pill pen has a blade embedded at its end and functions as a pill cutter, which is covered with a safety cap, which has a serrated convex surface so as to function as a pill grinder. The cutting and grinding surface is the interior vertex of the cap of the pill pen.

### BACKGROUND OF INVENTION

The pill pen of my design is a secure and convenient way to carry daily medications as well as a pleasant and constant reminder to take medications, as a patient just has to fasten the pill pen in the shirt pocket under his or her nose. It is perfectly suitable for those who are active and mobile and may not remember to take their medications on time.

The pill pen is composed of a cap and multiple cylindrical compartments, which are screwed together. It includes the first compartment which engages the cap with interlocking ridges, the last compartment which has a cutting blade and grinder, and the rest in the middle section, which are exchangeable in position. The cap has an interior concave surface for cutting and grinding a pill.

Everyone prefers to take medications which are identified. In contrast to placing labels on the surface of a container, I have designed a very user-friendly method to label a container from the inside. It is an elastic clip made from metal strip, metal wire or plastic, which presses the label against the interior wall of an compartment. The customer just makes a paper label for each medication and insert it between the clip and the interior wall of the compartment. The label with its information can be seen through the transparent wall.

Whenever a patient takes a pill from the pill pen, he or she is automatically reminded of the other pills to be taken and the schedules of taking them. Its compact size and flexibility make it a very convenient medication carrier and eliminates the clutter of medicine bottles.

The disadvantage of the available medication organizers is that all different medications are mixed together in one compartment without any label, which makes it impossible for anyone to identify each medication, even so for the patients themselves and the physicians.

When a patient develops low blood pressure due to anti-hypertensives or low blood sugar due to diabetic medication, he or she may not be aware of the culprit medications that should be adjusted or discontinued, because none of the medications is labeled in the medication organizer. The patient may continue to take the same concoction of unlabeled medications until more adverse outcome happens, such as fainting resulted from low blood pressure or low blood sugar.

Medication organizers typically have AM and PM partitions for medications. In fact, many medications need to be taken three times a day or even four times a day or taken only as needed at certain intervals (for example, every 4 to 6 hours as needed). Therefore, AM/PM partition is of little use and is actually problematic for such scheduling. Some medication organizers do have four partitions for the morning, noon, afternoon and bedtime dosing. However, only some of the medications need to be taken four times a day. Therefore, the space in such medication organizers is under-utilized. The four partitions for each day make the medication organizers bulky, too.

The designs of medication organizers limit the supply of medications to one week only, Monday through Sunday, while the space in each chamber is fixed, which could be either redundant or insufficient. On the contrary, the pill pen is flexible in that if one compartment is not sufficient to hold one week's supply of a particular medication due to its bigger size and the more frequency to be taken, another compartment can be used and then a label is inserted.

The pill pen with separate and labeled compartment for each kind of medication, ensures error-free administration of medications. Each compartment can be filled to the full capacity with medication, making efficient use of the space. Therefore, medication carrier like the pill pen is superior to the medication organizers.

It makes good economical sense and it is a very common practice for patients to obtain tablets in higher dosage and then take only half a tablet each time. Very often, the tablets of higher dosage may not cost much more than or even cost the same as the those of lower dosage.

Truly all-in-one, the self-contained pill cutter, pill grinder, cutting and grinding surface maximize the utility features that a pill container can possibly possess and meet all the special needs that may arise when a patient has to process his or her medications before taking them. The same is true for a caregiver who has to cut and grind medication for a patient in his or her care, who may be too sick to swallow a whole pill.

The pill cutter cuts a pill inside of the cap for the pen, so does the pill grinder. Hands are free from the pill when it is cut. Not even the smallest bit of a pill can be spilled when it is ground. The concave cutting surface inside of the cap ensures that any pill with a convex surface will be naturally centered. The interior wall of the cap along with the ridges guide and center the pill pen with the blade when cutting is performed. Therefore, it is a fool-proof, safe and accurate way to split a pill into equal halves.

Because of the very fact that many pills are made very tiny in size, it is considerably more accurate to split a very small pill with a blade on a handle under direct visualization as embodied in this design than with a hinged pill cutter while the small pill is out of sight when being cut. Sometimes, a pill needs to be cut into quarters, a task which has to be performed with a cutter similar to the one embodied by the pill pen.

The labeling method of my design can be automatically applied to any other kind of pill containers/organizers. Such design is significant in that it expands the functions of the conventional pill containers/organizers, so that they can be used as a weekly pill organizers as well as a container for multiple individual medications when labels are inserted. In the latter case, each compartment is filled up to make the full use of its space. If necessary, more than one compartment of the conventional pill container can be labeled and used for a single medication so as to provide such medication for a week or for a period as long as necessary. Therefore, the labeling method remedies the flaws associated with the pill organizers as mentioned above.

### SUMMARY OF THE INVENTION

The pill pen is a composed of two or more cylindrical compartments which are screwed together sequentially by means of spiral threads on each compartment. Each compartment is intended to hold a single kind of medication of at least one-week's supply. More than one compartment can be labeled and used for an individual medication if more space is needed. A self-made label is attached to the interior wall of each compartment by virtue of an elastic clip and its content is visible through the container. Such labeling method can be applied to the regular pill organizers and confers them the dual functions both as a weekly pill organizer and as pill containers for multiple individual medications.

A cap is slipped onto the joined cylindrical compartments and is engaged to the first cylindrical compartment by means of ridges on the interior wall of the cap and on the exterior wall of the first compartment, which interlock.

The last cylindrical compartment has a blade embedded in its terminal segment. A cap is screwed on to the terminal segment of the last compartment as a safety cover for the sharp blade. This safety cap has a finely serrated surface on its vertex and functions as a pill grinder to crush a pill against the interior concave surface of the cap of the pill pen. The customers may choose not to use the compartment with a blade and screw the safety cap onto any other compartment.

In a simpler version, the pill pen has no grinder, because grinder is rarely used. Therefore, the safety cap for the blade has a flat end and the pill pen can stand on its end. The concave cutting surface in the cap remains the same.

### BRIEF DESCRIPTION OF THE DRAWINGS

FIG. 1 is the exploded view of the two-compartment pill pen with a cap, label clip, pill cutter and pill grinder.

FIG. 2 is the side view of the two-compartment pill pen with a cap, label clip, pill cutter and pill grinder.

FIG. 3 is the first version of label clip, which is made of elastic metal wire and has a recurrent outline so as to increase its contact with a label. Each tip is immobilized onto the floor of the compartment when it is inserted into two slits which open in the opposite directions and push the tip in the opposite directions. The upper end of the clip is clicked into a small recess which prevents the clip from being bent away from the surface.

FIG. 4 is the second version of label clip made of elastic metal strip. Each splayed foot part is immobilized onto the floor of the compartment when it is inserted into a slit and is squeezed by both the slit and the interior wall of the compartment. The upper end of the clip is clicked into a small recess which prevents the clip from being bent away from the surface.

FIG. 5 is the exploded view of the five-compartment pill pen with a cap, pill cutter, pill grinder and label clips made from elastic metal wire and immobilized onto the floor of the compartment by two slits which hold and push each tip of the clip in the opposite directions.

FIG. 6 is exploded view of a five-compartment pill pen with a cap, pill cutter and label clips made from metal strips and immobilized onto the floor of the compartment when its splayed end is inserted into a slit and is squeezed by both the slit and the interior wall of the compartment. It has no grinder and is flat at both ends.

FIG. 7 is side view of the five-compartment pill pen with a pill cutter in the action of cutting a pill on the concave cutting and grinding surface inside of the cap of the pill pen.

FIG. 8 shows the first version of label clip installed onto the inner side of the cover of a conventional pill organizer. The label clip is made of metal wire, has a recurrent outline and is clamped onto the cover of a pill organizer by two slits which hold and push each tip of the clip in the opposite directions. The end of wire clip may be extended onto the side wall of a pill box and prop up its cover when it is opened. The upper end of the clip is clicked into a small recess which prevents the clip from being bent away from the surface.

FIG. 9 shows the second version of label clip installed onto the inner side of the cover of a conventional pill organizer. The label clip is made of metal strip. Its base is inserted into a slit on the cover of the pill organizer. The upper end of the clip is clicked into a small recess which prevents the clip from being bent away from the surface.

FIG. 10 shows the first version of label clip installed onto the inner side of the cover of a conventional pill organizer. The label clip is made of metal wire, has a concave or wavy outline and is fastened onto the cover of a pill organizer by two screws or rivets which go through a small ring formed by the wire clip and hole on the cover. The upper end of the clip is clicked into a small recess which prevents the clip from being bent away from the surface. The end of wire clip may be extended onto the side wall of a pill box and prop up its cover when it is opened.

FIG. 11 shows the first version of label clip which is made of elastic metal wire, installed onto the inner side of the cover of a conventional pill box and has a concave outline. One limb of the clip is bent away from the one-dimensional plane defined by the label clip so as to increase the tension exerted by the clip onto the cover of the pill box when its two foot parts are inserted into two tunnels on the cover of the pill box. The clip pivots around its foot parts.

FIG. 12 shows the first version of the label clip which is made of elastic metal clip and is coiled around the hinge of the pill box which joins together the cover and the box. The upper part of the label clip is bent away from one-dimensional plane defined by the label clip so as to increase the tension exerted bt the clip onto the cover of the pill box when its upper part is clicked into the two recesses which keep it straight. The other end of the clip is extended onto the side wall of the pill box and props up its cover when it is opened.

### DETAILED DESCRIPTION OF THE INVENTION

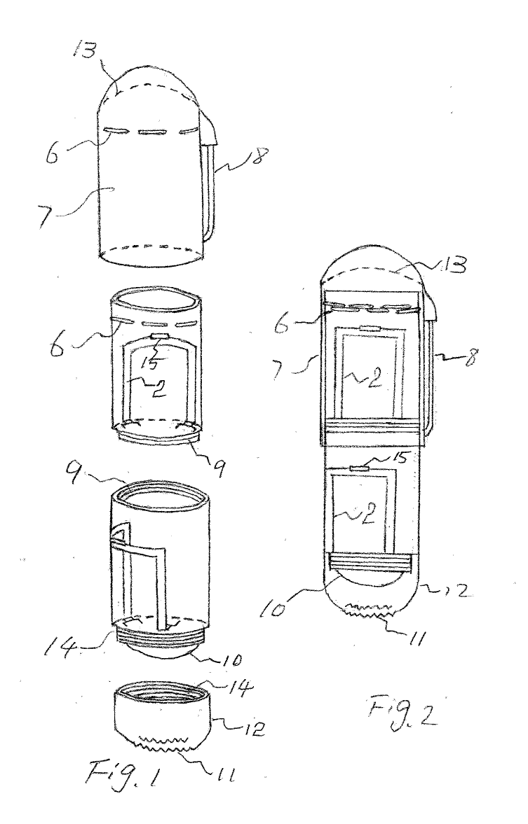

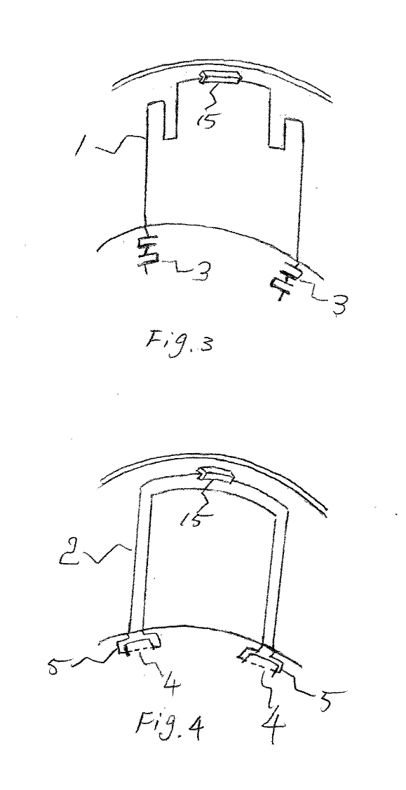

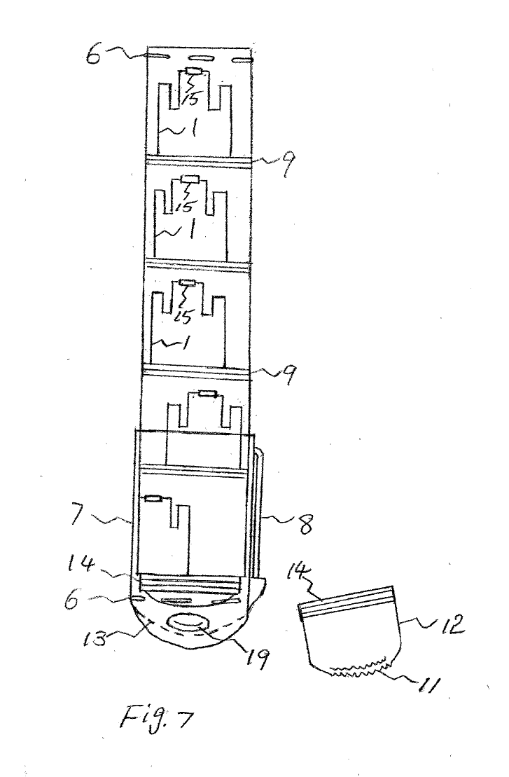

The pill pen shown in FIGS. 1, 2, 5, 6 and 7, is composed of multiple cylindrical compartments. They are sequentially screwed together by means of spiral threads 9 on the terminal segment of each compartment and the spiral threads 9 inside of the opening of the subsequent compartment. Each compartment is intended to hold a single kind of medication of at least one-week's supply.

The cap 7 is engaged to the first compartment by means of ridges 6 on the interior wall of the cap and the ridges on the exterior wall of the first compartment, which interlock. The reason to use ridges instead of spiral threads to attach the cap to the pill pen is to avoid the possible jamming of the spiral threads which would cause considerable difficulty to extract the first compartment from inside of the cap 7. The cap has a metal clip 8 to fasten the pill pen to a desirable spot, such inside a shirt pocket or a carry bag.

The terminal segment of the last compartment with a embedded cutting blade 10 is covered with a safety cap 12 to prevent accidental injury by cutting. This terminal segment with the blade 10 is longer than the terminal segment of the other compartment and has more spiral threads 14, so that the safety cap 12 won't fall off easily to expose the blade. The safety cap 12, with spiral threads 14 inside of its opening, is screwed on to the terminal segment, which has both spiral threads 14 and a cutting blade 10. The safety cap 12 can be screwed on to any other compartment if a customer chooses not to use the one with a blade.

The safety cap 12 has a finely serrated surface 11 on its vertex, by virtue of which the safety cap also functions as a pill grinder to grind a pill 15 against the interior concave cutting and grinding surface 13 of the cap 7 of the pill pen.

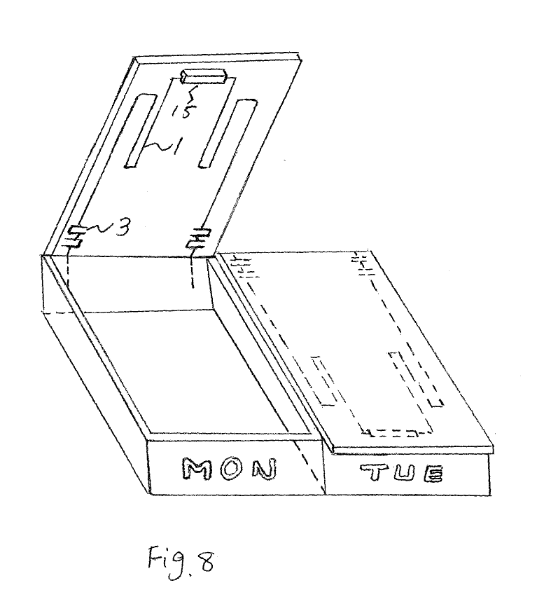

As shown in FIG. 7, with the safety cap 12 removed and the cutting blade 10 exposed, the pill pen is inserted into its cap 7, which stands on its end vertically. As almost all the pills have a convex surface (except the bar-shaped pills), such a pill will be naturally centered on the concave cutting and grinding surface 13 inside of the cap. Meanwhile, the interior wall of the cap along with the ridges on it will keep the pill pen centered inside of the cap. Therefore, it is ensured that a pill 19 will be split equally in the middle.

FIG. 6 demonstrates a pill pen without a grinder, as grinder is rarely used. The safety cap 12 for the blade 10 has a flat end, so that the pill pen can stand on its end.

More than one compartments can be used to hold a single medication for one-week's supply if more space is needed. To easily identify each medication, a self-made label (not shown) is attached to the interior wall of each compartment with the use of a clip 1,2.

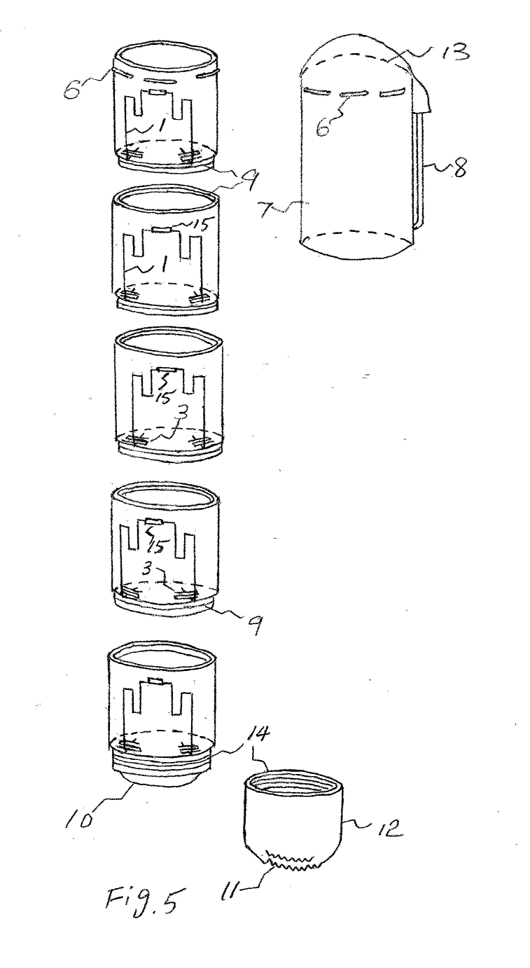

FIG. 3 demonstrates the first version of label clip 1, which is made of elastic metal wire and has a recurrent outline so as to increase its contact with a label. Each tip is immobilized onto the floor of the compartment when it is inserted into two slits 3 which open in the opposite directions and push the tip in opposite directions. The upper end of the clip is clicked into a small recess 15 which prevents the clip from being bent away from the surface.

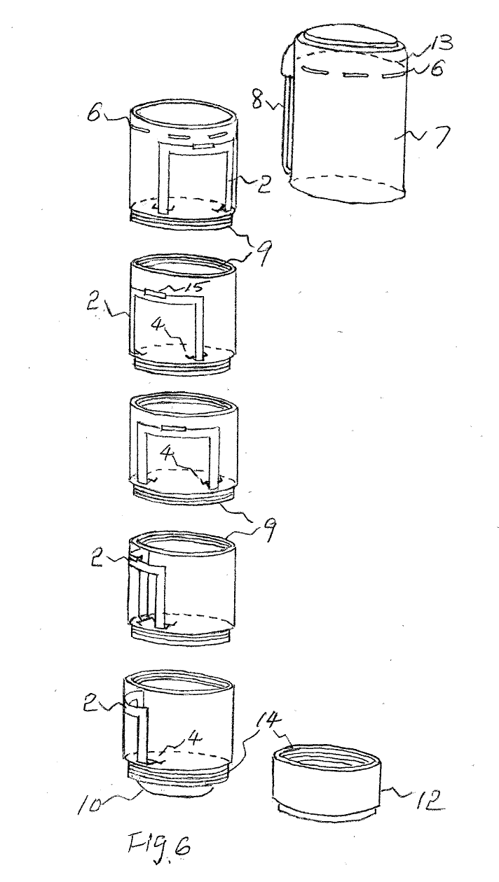

FIG. 4 demonstrates the second version of label clip 2 made of elastic metal strip. Each of its splayed foot parts 5 is immobilized onto the floor of the compartment when it is inserted into a slit 4 and is squeezed by both the slit 4 and the interior wall of the compartment. The upper end of the clip is clicked into a small recess 15 which prevents the clip from being bent away from the surface.

Such labeling method can be automatically applied to any other kind of pill containers/organizers and expands its functions. Besides its customary use as a weekly pill organizer, the labeling methods enable it to function as a container and carrier for multiple individual medications.

FIG. 8 shows the first version of label clip 1 installed onto the inner side of the cover of a conventional pill organizer. The label clip 1 is made of elastic metal wire, has a recurrent outline and is clamped onto the cover of the pill organizer by two slits 3 which hold and push each tip of the clip in the opposite directions. The upper end of the clip is clicked into a small recess 15 which prevents the clip from being bent away from the surface. The wire clip 1 may be extended onto the side wall of a pill box and prop up its cover when it is opened.

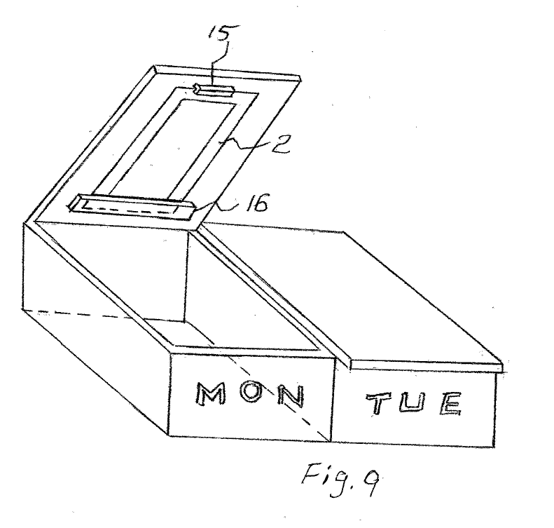

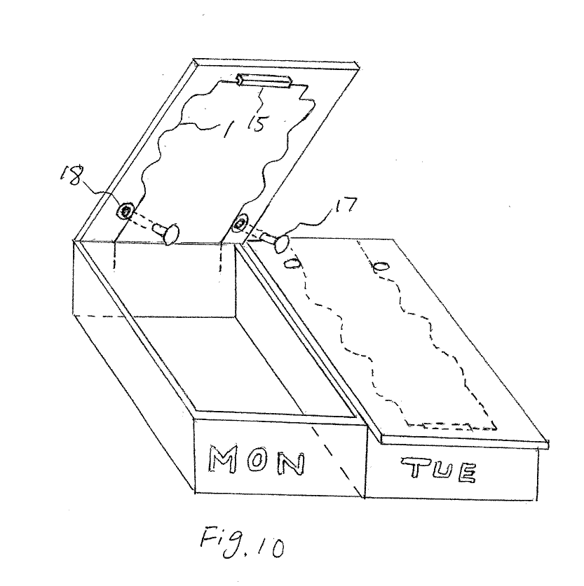

FIG. 9 shows the second version of label clip 2 installed onto the inner side of the cover of a conventional pill organizer. The label clip 2 is made of metal strip. Its base is inserted into a slit 16 on the cover of the pill organizer. The upper end of the clip is clicked into a small recess 15 which prevents the clip from being bent away from the surface.

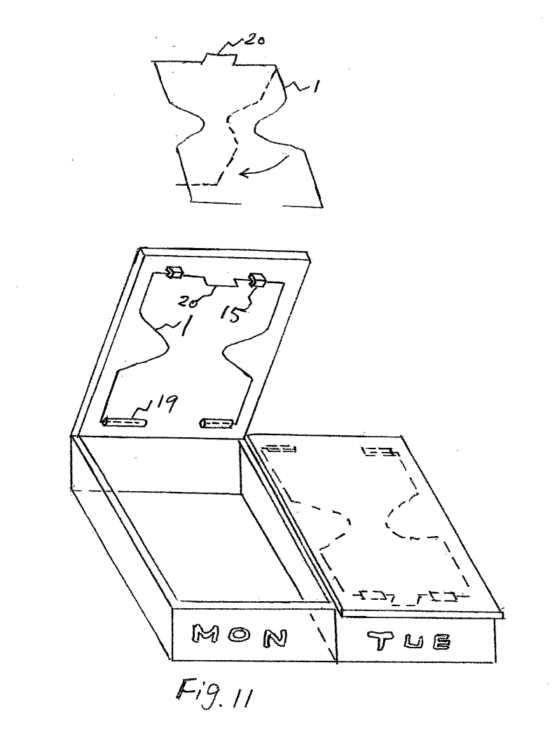

In addition to the slits of my design which function as a clamp for the label clip, a screw or rivet 17 can be used to fasten either version of label clips 1, 2 onto the cover of a pill box. As shown in FIG. 10, the label clip 1 is made of metal wire, has a wavy outline and is fastened onto the cover of a pill organizer by two screws or rivets 17 which go through a small ring 18 formed by the wire clip 1 and hole on the cover. The upper end of the clip is clicked into a small recess 15 which prevents the clip from being bent away from the surface. The end of wire clip may be extended onto the side wall of a pill box and prop up its cover when it is opened. The label clip 1 will not move along with the movement of the pill box cover and therefore the tension exerted by the label clip on the cover will not be affected because the clip is immobilized by the two screws 17.

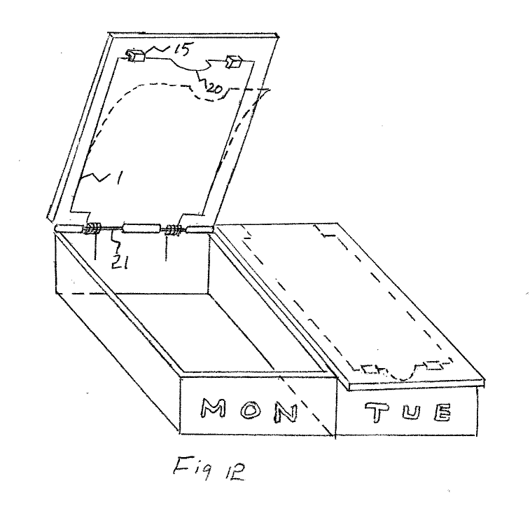

FIG. 11 shows the first version of label clip 1 which is made of elastic metal wire, installed onto the inner side of the cover of a conventional pill box and has a concave outline. One limb of the clip is bent away from the one-dimensional plane defined by the label clip so as to increase the tension exerted by the clip onto the cover of the pill box when its two foot parts are inserted into the two tunnels 19 on the cover of the pill box. The clip pivots around its foot parts. A tab 20 on the upper part of the label clip 1 is used to push the clip in and out of the recess 15 which keeps the clip flat on the cover of the pill box

FIG. 12 shows the first version of the label clip 1 which is made of elastic metal clip and is coiled around the hinge 21 of the pill box which joins together the cover and the box. The upper part of the label clip is bent away from one-dimensional plane defined by the label clip so as to increase the tension exerted by the clip onto the cover of the pill box when its upper part is clicked into the two recesses which keep it flat on the cover of the pill box. A tab 20 on the upper part of the label clip 1 is used to push the clip in and out of the recess 15. The other end of the label clip 1 is extended onto the side wall of the pill box and props up its cover when it is opened.

The pill pen is made from rigid, impermeable, semi-transparent or transparent material, such as plastic, so that the medications inside are visible. The surface may be decorated with relief-patterns to attenuate the spiral threads and division lines between the compartments and facilitate gripping.

What is claimed is:

1. the pill pen as a pill container and carrier, is comprised of multiple cylindrical compartments and a cap, is incorporated with a pill cutter, a pill grinder and a clip for label.

2. the said clip according to claim 1, is made of elastic materials such as metal strip and metal wire and is fastened onto the floor of a compartment by slits into which its end tips are inserted. The said clip attaches the label for each medication onto the interior wall of a compartment so that the content of label is visible through the wall. The label clip made from metal wire is wavy or recurrent in its outline so as to expand its contact with the paper label. The upper end of the clip is clicked into a small recess which prevents the clip from being bent away from the surface.

3. the said clip according to claim 2, can be applied to the available pill container or pill organizer to label individual medication in each compartment and to enable it to function as a container for multiple individual medications, in addition to their customary function as a weekly medication planner.

4. the said clip according to claim 3, is made of elastic material such as metal wire and metal strip and attaches the label for each medication onto the inner surface of the cover so that the content of label is visible through the cover. It is fastened onto the inner surface of the cover of a pill organizer/container by immobilizing its end tips with clamps (in the form of slits), or rivets or screws. Alternatively, its end tips pivot around its foot part or around the hinge of the pill box. The end segment of the clip can be extended onto the side wall of a pill box and prop up the cover when the pill box is opened. The upper end of the clip is clicked into a small recess which prevents the clip from being bent away from the surface. To increase the tension exerted by the label clip onto the cover of the pill box, part of the label clip is bent away from the one-dimensional plane as defined by the label clip and then is kept flat.

5. the cylindrical compartments of the said pill pen are exchangeable in position (except the first and last ones). Each compartment is intended to contain a single kind of medication for at least one week's supply.

6. the cap of the said pill pen covers the opening of the first compartment and has a concave interior vertex, which is the surface used for pill cutting and grinding.

7. the said cap of the pill pen according to claim 6, has a metal clip for it to fasten on a shirt pocket or secure to any other desirable location, such as inside a carry bag.

8. a cutting metal blade is embedded in the terminal segment of the last compartment and functions as a pill cutter. The terminal segment with a blade is longer than the terminal segment of other compartments and has more spiral threads, so that the safety cap will not fall off easily.

9. the pill pen according to claim 8, wherein a safety cover is screwed on to the terminal segment to cover the blade.

10. the said safety cover according to claim 9, has a finely serrated surface on its vertex and functions as a pill grinder.

11. the said safety cover, according to claim 10, can also be screwed on to the terminal segment of any other compartment, when the compartment with the cutting blade is not needed.
